(19) United States
(12) Patent Application Publication
(10) Pub. No.: US 2012/0310465 A1
(43) Pub. Date: Dec. 6, 2012

(54) VEHICLE NAGIVATION SYSTEM

(75) Inventors: Robert Boatright, Sandy, UT (US); David Olsen, Kaysville, UT (US); Levi Pearson, Lehi, UT (US)

(73) Assignee: Harman International Industries, Incorporated, Northridge, CA (US)

(21) Appl. No.: 13/151,433

(22) Filed: Jun. 2, 2011

(51) Int. Cl. G05D 1/02; G01C 21/36

(52) U.S. Cl. 701/25; 701/36

(57) ABSTRACT

A navigation system may include a positioning device for generating a position data signal, a geographical data storage device for generating a digital map data signal, a processing device for generating navigation information based on the position data signal and the digital map data signal, and a turn control device for generating output signals to activate and/or deactivate turn signals of the vehicle and/or to enable an autonomous vehicle control system to perform a driving maneuver. The turn control device may analyze the navigation information to detect when the distance to an approaching turn fails to exceed a predetermined limit or when the turn has been completed or bypassed. The turn control device may analyze the navigation information and a velocity data signal generated by a velocity sensing device to detect when the time to the approaching turn fails to exceed a predetermined limit.

### BACKGROUND OF THE INVENTION

1. Technical Field

The invention relates to a vehicle navigation system, and more particularly to a vehicle navigation system that is capable of interacting with an autonomous vehicle control system.

2. Related Art

Navigation systems are finding increasing use in vehicles to provide a vehicle user, the driver, with navigation instructions that help orient the driver when traveling unknown routes. In general, a navigation system includes a positioning device, which typically is based on a positioning system such as the global positioning system (GPS), for determining the vehicle's position with respect to a digital map representation. Navigation systems also typically include a processing system and suitable hardware and software to generate navigation information and to convey navigation instructions to the driver using the vehicle position and user input information such as a user-selected navigation route.

### SUMMARY

A vehicle navigation system evaluates vehicle and route parameters to determine when the vehicle is approaching a turn. The system determines a vehicle position and a vehicle velocity. The system may process this information to activate an appropriate turn signal on the vehicle when the vehicle reaches a predetermined distance from the turn. The navigation system also may process this information to activate an appropriate turn signal when the vehicle reaches a predetermined time from the turn. The navigation system also may send a permissive signal to an autonomous vehicle control system to enable the autonomous vehicle control system to complete the turn. The navigation system may use the vehicle position and vehicle velocity to determine when the vehicle has completed the turn or bypassed the turn. The navigation system may process this information to deactivate the turn signal when the vehicle has completed or bypassed the turn.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a block diagram of one example of a navigation system for use in a vehicle.

FIG. 2 is a block diagram of another example of a navigation system for use in a vehicle.

FIG. 3 is a block diagram of a turn control device.

FIG. 4 is a flowchart of a navigation system including one example of a turn control device.

FIG. 5 is a flowchart of a navigation system including another example of a turn control device.

FIG. 6 is a flowchart depicting one example of the issuance of output signals by a turn control device.

FIG. 7 is a flowchart depicting another example of the issuance of output signals by a turn control device.

FIG. 8 is a block diagram depicting communication between a head unit with an integrated navigation system and a vehicle lighting control system.

FIG. 9 is a block diagram depicting communication between a standalone navigation system, a head unit, and a vehicle lighting control system.

### DETAILED DESCRIPTION OF THE PREFERRED EMBODIMENTS

A navigation system may interface to a turn control device including turn control logic or may include the functionality of the turn control device and/or the turn control logic. If a vehicle, such as a structure for transporting persons and/or things, is approaching a turn along an intended route of travel, the turn control device may issue an appropriate output. A turn may be, for example, an intersection of two or more roadways, a divergence (i.e., a “Y”) in a roadway, an exit from a roadway such as an interstate highway exit, or any other roadway configuration that may require the vehicle to change a direction of travel to follow the intended route of travel. The output may activate a turn signal corresponding to the direction of the approaching turn. The turn signal of the vehicle may include, for example, lights mounted to the exterior of the vehicle. The lights may be mounted proximate the front and/or rear bumpers of the vehicle, along the sides of the body of the vehicle, and/or on the side view mirrors of the vehicle. The lights may be controlled by a lighting control system of the vehicle. Additionally, if the vehicle has completed or bypassed the turn, the turn control device may issue an appropriate output. The output may deactivate the turn signal that was activated previously by the system. The turn control device also may issue the appropriate outputs based on the vehicle approaching and subsequently performing or abandoning a lane change along the intended route of travel. A lane change may involve changing position along a roadway from one traffic lane to another traffic lane. A lane change may be performed in connection with, for example, moving in to a turn lane, moving to avoid traffic, or any other situation in which it may be desirable to move from one traffic lane to another. The turn control device may receive various data and employ the turn control logic to determine whether to issue an appropriate output to activate or deactivate an appropriate turn signal.

In the near future, autonomous, or unmanned, vehicles likely will share the road with manually driven vehicles. An autonomous vehicle may include various systems and/or subsystems that control the maneuvering of the vehicle without requiring human intervention. For example, a perception subsystem, a control subsystem, and/or a route planning subsystem may operate to enable the autonomous vehicle control system to drive the vehicle. The autonomous vehicle control system further may employ various electronic control units (ECUs) that may communicate with one another, for example, via a controller area network (CAN) bus of the vehicle. Examples of presently existing autonomous vehicles are the vehicles participating in programs such as the European Research Coordination Agency (EUREKA) Program for a European Traffic of Highest Efficiency and Unprecedented Safety (PROMETHEUS) Project and the Defense Advanced Research Projects Agency (DARPA) Grand Challenge. Control systems for autonomous vehicles may include navigation systems. It may be desirable for the navigation system of an autonomous vehicle to activate and/or deactivate the turn signals of the vehicle in response to, for example, a turn and/or a lane change. In this manner, the autonomous vehicle may be configured to obey various traffic regulations that may require the use of turn signals. Additionally, the autonomous vehicle may be configured to alert other autonomous vehicles and/or drivers of human controlled vehicles of an intended turn and/or lane change. It also may be desirable for the navigation system of an autonomous vehicle to communicate with an autonomous driving control system that may be responsible for performing various driving maneuvers, such as a turn and/or a lane change. The navigation system may be configured to issue signals, such as permissive signals, that may enable the autonomous driving control system to complete a driving maneuver.

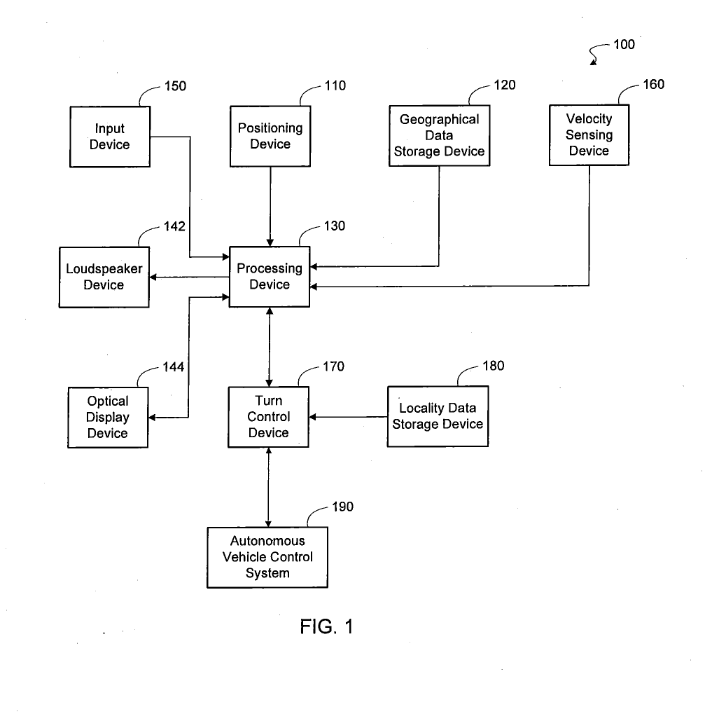

FIG. 1 is a block diagram of an example navigation system 100 configured for use in a vehicle. The navigation system may include and/or be interfaced to various devices and/or systems. The navigation system 100 may include a positioning device 110 which may determine the position of the vehicle in which the navigation system may be installed or operated. For example, the positioning device 110 may include a GPS receiver or a comparable satellite positioning system receiver for receiving positioning signals from navigation satellites. A digital map representation may be stored in a geographical data storage device 120. The geographical data storage device 120 may include, for example, a hard disk device, a CD-ROM device, a DVD device, a ROM memory device, or any other non-transitory data storage device. In addition, rewritable non-volatile memory, such as flash memory, may be provided to store processing information in a flexible way and to maintain the stored information even in the case of a power outage.

The navigation system 100 may include a processing device 130 for generating navigation information. The processing device 130 may be configured as a general processor, digital signal processor, application specific integrated circuit, field programmable gate array, analog circuit, digital circuit, server processor, combinations thereof, or other now known or later developed processor. The processing device 130 may be configured as a single device or combination of devices, such as associated with a network or distributed processing. Any of various processing strategies may be used, such as multi-processing, multi-tasking, parallel processing, remote processing, centralized processing or the like. The processing, device 130 may be responsive to or operable to execute instructions stored as part of software, hardware, integrated circuits, firmware, micro-code, or the like. The processing device 130 may receive position data from the positioning device 110 and digital map data from the geographical data storage device 120 to determine a current position of the vehicle with respect to the digital map representation. The processing device 130 may generate navigation information on the basis of the current position and/or other received data such as, for example, a destination entered by the driver. The navigation information may include navigation instructions such as, for example, indications of which action should be taken to navigate the vehicle on a preselected navigation route (e.g., “turn left”, “turn right”, or “follow the course of the road”). The navigation information also may include warnings relating to the navigation route. The warnings may include, for example, warnings relating to abnormal road conditions, speed limits, or other conditions.

The navigation system 100 may include various output devices to present or annunciate the navigation information to the vehicle user (e.g., the driver). The output devices may include a loudspeaker device 142 and/or an optical display device 144. The loudspeaker device 142 may be a dedicated component of the navigation system 100. Alternatively, the loudspeaker device 142 may be a component of a vehicle entertainment system, such as a car radio, CD player, MP3 player, tape player, or a combination of such devices. If the navigation system 100 shares use of the loudspeaker device 142 with a vehicle entertainment system, the navigation system 100 may include an interface to permit transmission of the output signals corresponding to navigation information to the vehicle entertainment signal. This may be accomplished via a digital data bus in the vehicle. The optical display device 144 may be a full graphic display, such as, for example, a liquid-crystal display, a thin-film transistor display, or a cathode-ray tube display. The optical display device 144 also may be a projection display, such as a head-up display in which optical information is projected onto a windscreen of the vehicle. The optical display device 144 also may be combined with an input device. For example, the optical display device 144 may be configured as a touchscreen device. The optical display device 144 may be a dedicated component of the navigation system or may be used together with other vehicle systems, such as, for example, a multi-media system.

The processing device 130 may be coupled to the positioning device 110 to receive a position data signal, to the geographical data storage device 120 to receive digital map data, to the loudspeaker device 142 to provide an acoustical output data signal, and/or to the optical display device 144 to provide an optical output data signal. The processing device 130 may evaluate position data received from the positioning device 110 via the position data signal and digital map data received from the geographical data storage device 120 to generate navigation information to be output to the vehicle user. The output navigation information may be a corresponding acoustical output signal and/or optical output signal.

The navigation system 100 also may include an input device 150. The processing device 130 may be coupled to the input device 150 to provide the vehicle user with control over functions of the processing device 130. The input device 150 may include suitably designed switches and/or a keyboard. The input device 150 may be used, for example, to activate or deactivate the navigation system, to select the navigation route, and/or to select between different navigation system output mode s. The navigation system output modes may include, for example, a mode providing for acoustic output of navigation information only, a mode providing for optical output of navigation information only, a mode providing for both acoustical and optical output of navigation information, or other suitable modes.

The navigation system 100 may include and/or be interfaced to a velocity sensing device 160 to detect a current velocity of the vehicle. The velocity sensing device 160 may include motion sensors, such as Anti-Lock Braking System (ABS) wheel sensors. These sensors may be positioned in proximity to each individual wheel or within a differential of the vehicle. The processing device 130 may be coupled to the velocity sensing device 160 to receive a velocity data signal. Alternatively, or additionally, the processing device 130 may be configured to calculate the velocity of the vehicle using the position data received from the positioning device 110. The processing device 130 may calculate the velocity by analyzing the change in the position of the vehicle over a period of time.

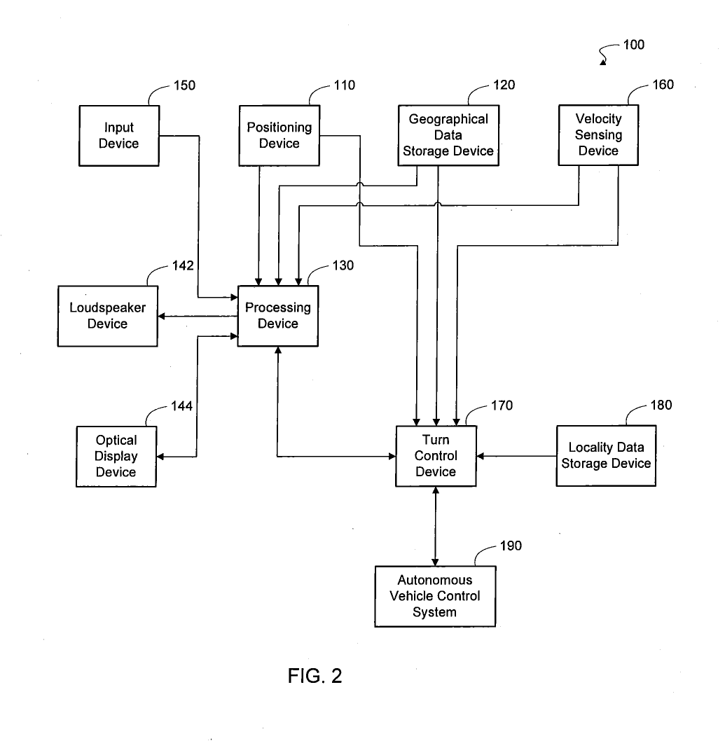

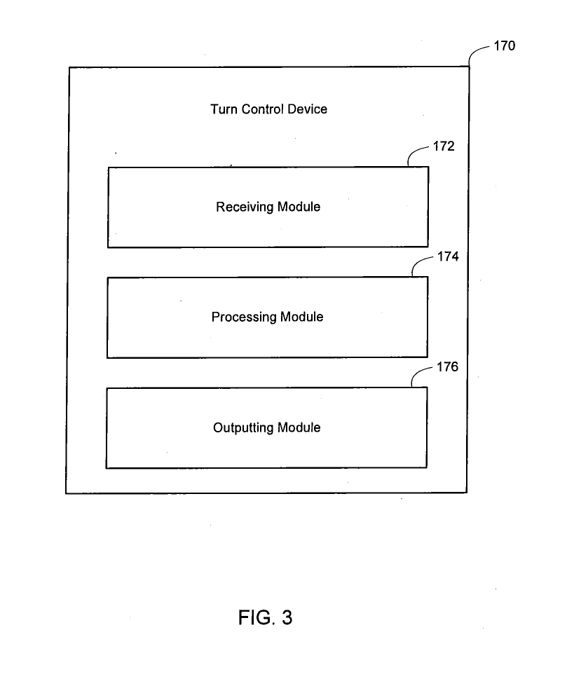

The navigation system 100 may include and/or be interfaced to a turn control device 170. The turn control device 170 may be integrated with the processing device 130, coupled to the processing device 130, and/or configured as a standalone device interfaced to the navigation system 100. The turn control device 170 may receive data from various other devices. For example, the turn control device 170 may receive position data from the positioning device 110, digital map data from the geographical data storage device 120, navigation information from the processing device 130, velocity data from the velocity sensing device 160, and/or locality data from a locality data storage device 180. The turn control device 170 may receive data directly from the various other devices as shown in FIG. 2 and/or indirectly via the processing device 130 as shown in FIG. 1. For example, the processing device 130 may receive the position data, digital map data, navigation information, velocity data, and/or locality data and pass some or all of the received data to the turn control device 170. As shown in FIG. 3, the turn control device 170 may have a receiving module 172 configured to receive data from the various other devices. The turn control device 170 may have a processing module 174 configured to employ turn control logic to analyze the received data. The turn control device 170 may have an outputting module 176 configured to issue an appropriate output based on the analysis as further described later.

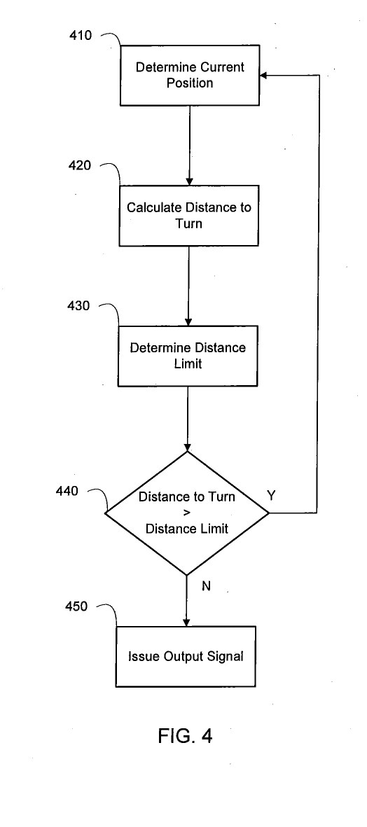

The turn control device 170 may employ the turn control logic to evaluate the data received, directly or indirectly, from the positioning device 110, the geographical data storage device 120, the velocity sensing device 160, the locality data storage device 180, and/or the processing device 130. FIG. 4 is a flowchart of a navigation system including a turn control device. At act 410, the current position of a vehicle with respect to a digital map representation may be determined by the navigation system. At act 420, a state value may be calculated by the navigation system. The state value may be, for example, a distance to turn value. The distance to turn may be calculated using the current position of the vehicle with respect to the digital map representation and the navigation information, such as the preselected navigation route. In other words, the distance to turn may represent the distance along the preselected navigation route between the current position of the vehicle and the position of an approaching turn along the preselected navigation route. Preferably, the distance to turn may represent the distance along the preselected navigation route between the current position and the position of the next turn that the vehicle may be expected to encounter when travelling along the preselected navigation route.

A state value limit, such as a distance limit, may be determined by the navigation system at act 430. The distance limit may be a predetermined value. For example, the distance limit may be a predetermined value ranging from about 10 meters (m) to about 100 m. The predetermined value may be a value selected by the user of the navigation system that falls within a predetermined range.

The distance limit also may be determined based on a current velocity of the vehicle. The navigation system may determine the current velocity of the vehicle and correlate the current velocity with velocity-distance data. For example, the distance limit may have a lower value when the current velocity of the vehicle is lower and a higher value when the current velocity is higher. This may allow the turn signal of the vehicle to be activated a greater distance ahead of the turn when the vehicle is travelling at a higher velocity than when the vehicle is travelling at a lower velocity. Such a configuration may be desirable to avoid confusion on the roadways. For example, it may be undesirable to activate the turn signal 100 m ahead of the approaching turn when travelling along a city or residential street where the preselected navigation route may pass through multiple intersections in the 100 m before reaching the turn. Other drivers may be confused as to where the vehicle intends to turn. Because the velocity of the vehicle is likely to be reduced when travelling along such a street, providing a reduced distance limit when the vehicle is travelling at a reduced velocity may help to avoid this type of confusion. On the other hand, it may be undesirable to activate the turn signal only 10 m ahead of the approaching turn when travelling along, for example, a state or interstate highway. Because the velocity of the vehicle is likely to be increased when travelling along a highway, other vehicles or drivers may be caught off guard by the relatively short notice provided before the vehicle reaches the turn. Providing an increased distance limit when the vehicle is travelling at an increased velocity may help to avoid startling these other vehicles or drivers. It also is contemplated that the distance limit may be based on the type of road (e.g., residential street, city street, state highway, interstate highway, etc.) on which the vehicle is travelling as opposed to, or in addition to, the velocity of the vehicle.

Data related to road types may be available to the navigation system in the form of roadway data. The roadway data may be received as part of the geographical data stored within the geographical data storage device. For example, the geographical data may include roadway distance limits corresponding to various locations. The navigation system may correlate the current location with the roadway distance limits to determine the distance limit for the particular road and/or road type on which the vehicle is travelling.

In one example, the distance limit may range from about 10 m to about 50 m when the current velocity of the vehicle is less than or equal to about 50 kilometers per hour (kph) and may range from about 50 m to about 100 m when the current velocity is greater than about 50 kph. More than two velocity ranges may be provided. To that end, in another example, the distance limit may range from about 10 m to about 40 m when the current velocity is less than or equal to about 50 kph, from about 40 m to about 70 m when the current velocity is greater than about 50 kph but less than or equal to about 100 kph, and from about 70 m to about 100 m when the current velocity is greater than about 100 kph. These ranges are intended to be exemplary rather than limiting. Additional velocity ranges (e.g., three, four, or more ranges) and corresponding distance limits may be provided. Providing a greater number of velocity ranges may allow the time that a turn signal is active prior to the vehicle reaching the turn to be relatively constant regardless of the velocity of the vehicle. In other words, multiple velocity ranges may be used to activate the turn signal at approximately the same time before reaching the turn regardless of the velocity of the vehicle. The velocity ranges and corresponding distance limits may be received by the processing device 130 and/or the turn control device 170 of the navigation system in the form of velocity-distance data. The velocity-distance data may be stored in a velocity-distance data storage device that may be integrated with, coupled to, or interfaced to the navigation system.

The distance limit also may be determined based on locality data received from a locality data storage device 180. The locality data may include regulatory limits such as regulatory distance limits. The regulatory distance limits may include signaling distances required by federal, state, and/or local laws and/or regulations of various different localities. The navigation system may use the current position of the vehicle and the locality data to determine the regulatory distance limit for the location (e.g., country, state, and/or city) in which the vehicle is travelling. The distance limit determined by the navigation system may be equal to the regulatory distance limit corresponding to the current position of the vehicle. Alternatively, the distance limit determined by the navigation system may be equal to the regulatory distance limit plus or minus an adjustment factor. The adjustment factor may be selected by the user of the navigation system. It is contemplated that the regulatory distance limit may depend on various other factors such as, for example, the velocity of the vehicle and/or the type of road upon which the vehicle is travelling. It also is further contemplated that a regulatory distance limit may not be available for all localities. If a regulatory distance limit is not available, the navigation system may set the regulatory distance limit to a null value such that the regulatory distance limit may not be considered in determining the distance limit.

The distance to turn may be compared to the distance limit at act 440, and a determination may be made as to whether the distance to turn exceeds the distance limit. If the distance to turn exceeds the distance limit, the turn control logic may return to act 410. If the distance to turn does not exceed the distance limit, the turn control device may issue an appropriate output signal at act 450 as further described below.

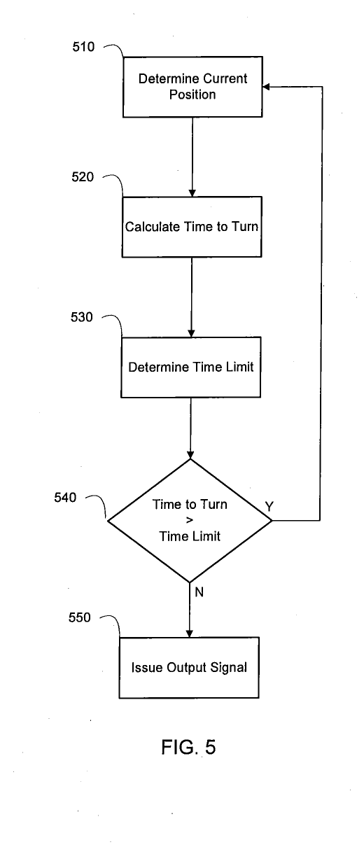

FIG. 5 is a flowchart of a navigation system including another example of a turn control device. At act 510, the current position of the vehicle with respect to the digital map representation may be determined by the navigation system. At act 520, a state value, such as a time to turn value, may be calculated by the navigation system. The time to turn may be calculated using the current position of the vehicle with respect to the digital map representation, the navigation information such as the preselected navigation route, and/or the current velocity of the vehicle. To calculate the time to turn, the navigation system first may determine the distance to turn as described above. The distance to turn may be divided by the current velocity to calculate the time to turn.

A state value limit, such as a time limit, may be determined by the navigation system at act 530. The time limit may be a predetermined value. For example, the time limit may be a predetermined value ranging from about 3 seconds to about 30 seconds. The predetermined value may be a value selected by the user of the navigation system that falls within a predetermined range. The time limit also may be determined based on the current velocity of the vehicle, similar to the determination described above with respect to the distance limit. For example, the navigation system may correlate the current velocity with velocity-time data. Velocity ranges and corresponding time limits may be received by the processing device 130 and/or the turn control device 170 of the navigation system in the form of velocity-time data which may be stored in a velocity-time data storage device that may be integrated with, coupled to, or interfaced to the navigation system. The time limit also may be determined based on the locality data received from the locality data storage device as described above with respect to the distance limit. The locality data may include regulatory time limits such as those required by federal, state, and/or local laws and/or regulations of various different localities. The navigation system may use the current position of the vehicle and the locality data to determine the regulatory time limit for the location (e.g., country, state, and/or city) in which the vehicle is travelling. The time limit determined by the navigation system may be equal to the regulatory time limit received via the locality data. Alternatively, the time limit determined by the navigation system may be equal to the regulatory time limit received via the locality data plus or minus an adjustment factor. The adjustment factor may be selected by the user of the navigation system. The time limit also may be determined based on the type of road on which the vehicle is travelling. For example, roadway time limits similar to the roadway distance limits described earlier may be received as part of the geographical data.

The time to turn may be compared to the time limit at act 540. If the time to turn exceeds the time limit, the turn control logic may return to act 510. If the time to turn does not exceed the time limit, the turn control device may issue an appropriate output signal at act 550 as further described below.

It is further contemplated that the examples illustrated by FIGS. 4 and 5 may be combined in a single turn control device. For example, the turn control logic may be configured to compare the distance to turn to the distance limit and the time to turn to the time limit. If either the distance to turn does not exceed the distance limit or the time to turn does not exceed the time limit, the turn control logic may issue an appropriate output signal. Alternatively, if both the distance to turn does not exceed the distance limit and the time to turn does not exceed the time limit, the turn control device may issue an appropriate output signal.

The turn control device 170 may issue various output signals based on the received data and the analysis performed by the turn control logic. The output signals may include turn signal activation output signals and/or turn signal cancellation output signals. The turn signal activation output signals further may include a right turn signal activation output signal and a left turn signal activation output signal. The right turn signal activation output signal may cause a right turn signal of the vehicle to be activated. Likewise, the left turn signal activation output signal may cause a left turn signal of the vehicle to be activated.

The turn control device 170 also may issue permissive output signals. The permissive output signals may be received by, for example, an autonomous vehicle control system 190 of an autonomous vehicle. The permissive output signals may enable the autonomous vehicle control system 190 to perform various driving maneuvers. For example, a permissive turn signal may enable the autonomous vehicle control system 190 to perform a turn maneuver. For further example, a permissive lane change signal may enable the autonomous vehicle control system 190 to perform a lane change maneuver. Once the autonomous vehicle control system has received a permissive signal from the navigation system, the autonomous vehicle control system may perform a driving maneuver. The autonomous vehicle control system may communicate with various other vehicle systems including, for example, a Collision Avoidance Drivers Assistance system having sensors (e.g. cameras, RADAR, and/or LIDAR) to detect obstructions in an intended path of the driving maneuver or other safety issues, throttle and/or braking control systems to adjust the velocity of the vehicle so that the vehicle may complete the driving maneuver at a velocity that is safe for the vehicle and/or comfortable for the passengers, and steering wheel angle control systems to steer the vehicle through the driving maneuver.

By issuing permissive output signals, the navigation system 100 may perform an interlock function with respect to the autonomous vehicle control system 190. In other words, the navigation system 100 may enable the autonomous vehicle control system 190 to perform a particular maneuver only when the navigation system 100 determines that it is appropriate to do so. The permissive output signals may be issued by the turn control device 170 concurrently with the turn signal activation output signals and/or turn signal cancellation output signals. By determining when the autonomous vehicle control system may complete a driving maneuver and/or operating the appropriate turn signals to accompany the driving maneuver, the navigation system 100 may aid the vehicle in conforming to legal and/or safety requirements when performing a driving maneuver.

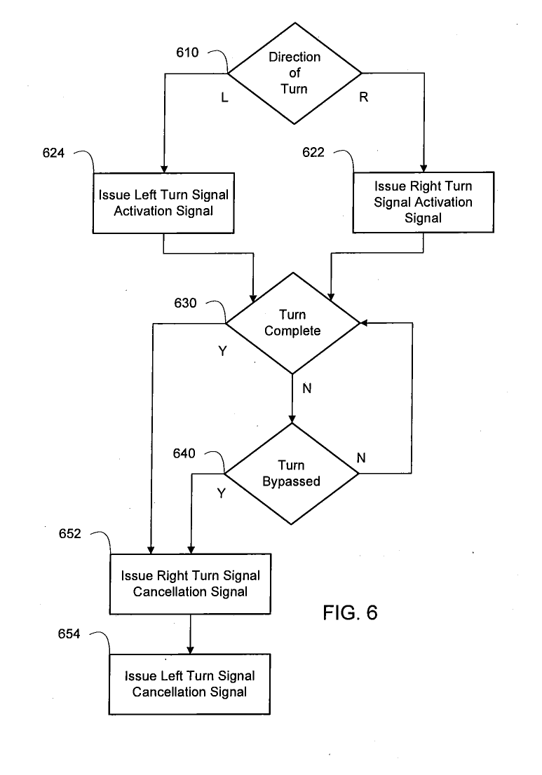

The turn control device 170 may issue an appropriate output signal based on the analysis performed by the turn control logic as described above. FIG. 6 is a flowchart illustrating the issuance of output signals by the turn control device. At act 610, a direction (e.g., left or right) of an approaching turn may be determined by the navigation system. The direction of the turn may be determined using the navigation data such as the preselected navigation route. If the direction of the turn is to the right, the turn control device may issue a right turn signal activation output signal and/or a permissive right turn output signal at act 622. The right turn signal activation output signal may activate the right turn signal of the vehicle. The permissive right turn output signal may enable the autonomous vehicle control system to perform a right turn. Conversely, if the direction of the turn is to the left, the turn control device may issue a left turn signal activation signal and/or a permissive left turn output signal at act 624. The left turn signal activation signal may activate the left turn signal of the vehicle. The permissive left turn output signal may enable the autonomous vehicle control system to perform a left turn. In other words, the turn control device may issue the appropriate output signal to activate the turn signal corresponding to the direction of the approaching turn along the preselected navigation route upon which the vehicle is travelling. The turn control device also may issue the appropriate permissive output signal to enable the autonomous vehicle control system to perform the approaching turn.

At act 630, the navigation system may determine whether the vehicle has completed the turn. Such a determination may be made based on various data received by the navigation system. For example, the current location of the vehicle may be compared to the location of the turn along the preselected navigation route. If the turn is positioned ahead of the current position along the preselected navigation route, the vehicle has not completed the turn. Conversely, if the turn is positioned behind the current position along the preselected navigation route, the vehicle has completed the turn.

In another example, a direction signal received from a direction device may be used to determine whether the vehicle has completed the turn. The direction device may be configured, for example, as a magnetic compass. The direction signal from the direction device may indicate the current direction of the vehicle, or in other words, the direction in which the vehicle is pointed. The current direction of the vehicle may be compared to the direction of the preselected navigation route ahead of the turn. If the current direction is substantially equivalent (e.g., within plus or minus about 5 degrees) to the direction of the preselected navigation route ahead of the turn, the vehicle has not completed the turn. Conversely, if the current direction is not substantially equivalent to the direction of the preselected navigation route ahead of the turn, the vehicle has completed the turn. Similarly, the current direction also may be compared to the direction of the preselected navigation route following the turn. If the current direction is not substantially equivalent to the direction of the preselected navigation route following the turn, the vehicle has not completed the turn. Conversely, if the current direction is substantially equivalent to the direction of the preselected navigation route following the turn, the vehicle has completed the turn. The determination also may be based on a change in current direction. For example, the navigation system may store the current direction of the vehicle concurrent with act 610. The navigation system may determine whether the vehicle has completed the turn by comparing the stored direction with the current direction at act 630 to determine whether the direction of the vehicle has changed by more than a predetermined amount. For example, if the difference between the current direction and the stored direction is less than about 30 degrees, the vehicle has not completed the turn. Conversely, if the difference between the current direction and the stored direction is at least about 30 degrees, the vehicle has completed the turn.

It is contemplated that more than one method of determining whether the vehicle has completed the turn may be combined. For example, the navigation system may determine that the vehicle has completed the turn when either the turn is positioned behind the current position along the preselected navigation route or the direction of the vehicle has changed. Any other combination also may be employed. Such a combination of methods may increase the accuracy of the navigation system in determining whether the vehicle has completed the turn. If the vehicle has completed the turn, the turn control logic may skip act 640 and perform act 652 and/or 654 as described below. If the vehicle has not completed the turn, the navigation system may determine whether the vehicle has bypassed the turn as described below.

The navigation system may determine whether the vehicle has bypassed the turn at act 640. The vehicle may bypass a turn for a variety of reasons. For example, the driver may simply choose not to complete the turn. In another example, the autonomous vehicle control system may be prevented from completing the turn because, for example, a camera system may detect an obstruction or other safety issue preventing the turn. In yet another example, the navigation system may choose not to complete the turn based on, for example, information related to traffic conditions or road closures. The determination of whether the vehicle has bypassed the turn may be made based on various data received by the navigation system. For example, the current location of the vehicle may be compared to the preselected navigation route. If the current position is along the preselected navigation route, the vehicle has not bypassed the turn. Conversely, if the current position is not along the preselected navigation route, the vehicle has bypassed the turn. If the vehicle has not bypassed the turn, the turn control logic may return to act 630. If the vehicle has bypassed the turn, the turn control device may issue an appropriate output signal as described below.

The turn control device may be configured to issue turn signal cancellation output signals including a right turn signal cancellation output signal and a left turn signal cancellation output signal. The right turn signal cancellation output signal may cause, the right turn signal of the vehicle to be deactivated. Likewise, the left turn signal cancellation output signal may cause the left turn signal of the vehicle to be deactivated. The turn control device may issue a turn signal cancellation output signal to deactivate the appropriate turn signal. For example, if the direction of the turn, as determined at act 610, is to the right, the turn control device may issue a right turn signal cancellation output signal at act 652. Conversely, if the direction of the turn is to the left, the turn control device may issue a left turn signal cancellation output signal at act 654. FIG. 6 illustrates that the turn control device may issue both right and left turn signal cancellation output signals at acts 652 and 654 rather than referencing the turn direction from act 610. In other words, the turn control device may issue the output signals to deactivate both right and left turn signals regardless of which turn signal had previously been activated. The turn control device also may cancel the appropriate turn signal by deactivating the active turn signal activation output signal. In other words, the turn signal may be deactivated by the issuance of a turn signal cancellation output signal and/or by ceasing issuance of a turn signal activation output signal. The turn control device further may cancel the permissive turn output signal concurrently with issuance of the turn signal cancellation output signal. Cancelling the permissive turn output signal may prevent the autonomous vehicle control system from performing a driving maneuver, such as a turn, until the navigation system issues a permissive turn output signal. The autonomous vehicle control system may process a cancelled permissive output signal similar to a bypassed or abandoned turn or lane change.

Once the appropriate turn signal has been deactivated, meaning that the turn has been completed or bypassed, the steps described above with reference to FIGS. 4-6 may be repeated with respect to another turn along the preselected navigation route of the vehicle. Preferably, the other turn is the turn following the completed or bypassed turn along the preselected navigation route. The other turn following a bypassed turn may be along a new preselected navigation route generated by the navigation system in response to the turn having been bypassed.

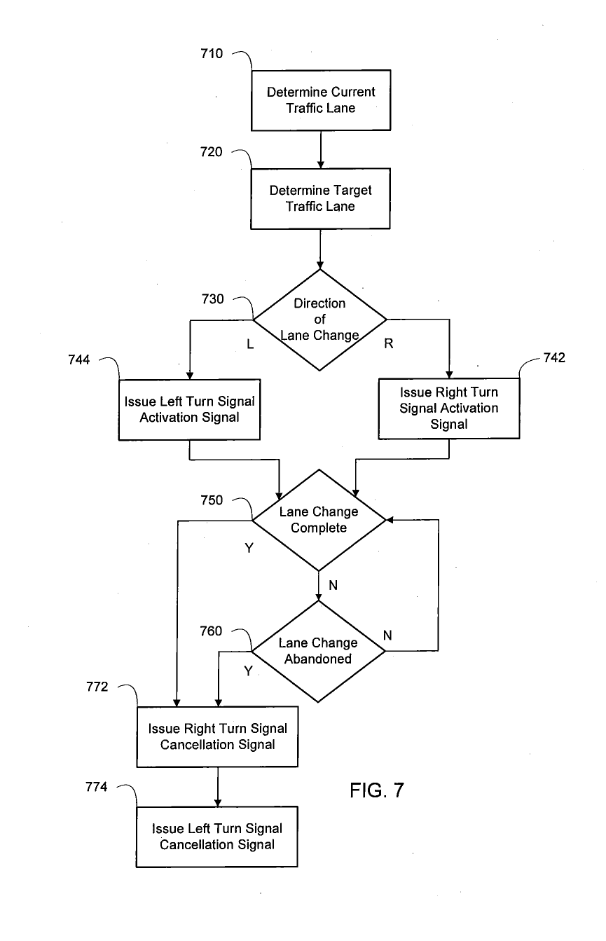

In another example, a navigation system may include a turn control device configured to issue an appropriate output to signal an approaching lane change expected to be made by a vehicle as shown in FIG. 7. The navigation system may receive a signal associated with the initiation of a lane change from, for example, the autonomous vehicle control system 190 of an autonomous vehicle. The autonomous vehicle control system may initiate a lane change, for example, to direct the vehicle into the proper lane to complete an approaching turn (e.g., a turn lane or the lane nearest an approaching exit ramp) or to navigate the vehicle through traffic. Alternatively, the navigation system 100 may initiate a lane change. The navigation system may initiate a lane change, for example, to direct the driver to move the vehicle into the proper lane to complete an approaching turn.

Once a lane change has been initiated (e.g., by the autonomous vehicle control system or the navigation system), the navigation system may determine a current traffic lane in which the vehicle is travelling at act 710. The current traffic lane may be determined using any means. For example, the current traffic lane may be determined using position data received from the positioning device and/or digital map data received from the geographical data storage device. The digital map data may include data related to the number of traffic lanes that may be available on a given roadway. The navigation system may use the position data to determine in which of the available traffic lanes the vehicle is travelling. The current traffic lane also may be determined by various other devices and/or systems included in the vehicle and/or the navigation system. For example, a camera or other optical sensing device may be used to determine a relative position of the vehicle with respect to the surface of the roadway and/or various markers on the roadway surface (e.g., lane markers).

The navigation system may determine the position of a target traffic lane at act 720. The target traffic lane may be the traffic lane into which the vehicle is expected to move. The target traffic lane may be provided by, for example, the autonomous vehicle control system, the navigation system, or the driver. The positions of the current and target traffic lanes may be compared at act 730 to determine the direction of the lane change. If the target traffic lane is to the right of the current traffic lane, the navigation system may issue a right turn signal activation signal and/or a permissive right turn output signal at act 742. Conversely, if the target traffic lane is to the left of the current traffic lane, the navigation system may issue a left turn signal activation signal and/or a permissive left turn output signal at act 744.

The navigation system may determine whether the lane change is complete at act 750. The determination may be made by determining whether the current traffic lane at act 750 is the same as the current traffic lane determined at act 710. The determination also may be made or supplemented by data received from any of a variety of other vehicle sensors. For example, a steering wheel sensor may detect rotational movement of the steering wheel of the vehicle to determine when the vehicle has been steered into another traffic lane. Other sensors also may include velocity sensors, wheel alignment sensors, and/or gyroscopes. If the lane change is complete, the navigation system may issue the right and/or left turn signal cancellation signal at acts 772 and 774, respectively. The navigation system also may cancel the permissive turn output signal concurrently with issuance of the turn signal cancellation signal. As discussed above with respect to FIG. 6, the navigation system may issue both right and left turn signal cancellation signals regardless of the direction of the lane change. If the lane change is not complete, the navigation system may determine whether the lane change has been abandoned at act 760.

The navigation system may receive a signal indicating an abandoned lane change from the autonomous vehicle control system or the driver. Alternatively, the navigation system may detect the abandonment of a lane change. For example, if the navigation system initiated the lane change to prepare for an approaching turn, the system may determine that the lane change has been abandoned when the vehicle fails to complete the turn. Failure to complete the turn may be determined as described above with reference to detecting a bypassed turn. Alternatively, the navigation system may determine that the lane change has been abandoned by the passage of a predetermined period of time. For example, the navigation system may determine that the lane change has been abandoned if the lane change has not been completed within 30 seconds of the issuance of the turn signal activation signal. In another alternative, the navigation system may determine that the lane change has been abandoned if the vehicle travels a predetermined distance without completing the lane change. In yet another alternative, the navigation system may determine that the lane change has been abandoned by determining that the lane change is precluded by an obstruction, such as traffic in the target traffic lane. The navigation system may make such a determination using data provided by, for example a camera or other optical sensing device. If the lane change has not been abandoned, the navigation system may return to act 750. If the lane change has been abandoned, the navigation system may issue the right and/or left turn signal cancellation signals and/or cancel the permissive turn output signal at acts 772 and/or 774.

Various vehicle systems may communicate via various communication networks. For example, a navigation system may be part of an infotainment system of a vehicle. Alternatively, a navigation system may be a system that is discrete from a vehicle and configured to communicate with a vehicle system. For example, the navigation system may be part of a standalone system or integrated into a smartphone or other mobile device and configured to communicate with an infotainment system of the vehicle. In any event, communications for the infotainment system may be carried by a networking system such as Media Oriented Systems Transport (MOST), Ethernet, Universal Serial Bus (USB), and/or Institute of Electrical and Electronics Engineers (IEEE) 1394. The turn signals of a vehicle may be part of a vehicle lighting system. The vehicle lighting system may be part of a vehicle control system. Communications for the vehicle control system, and/or various subsystems of the vehicle control system, may be carried by a CAN. The autonomous vehicle control system may be configured as a single ECU within the vehicle or a network of multiple ECUs. The autonomous vehicle control system may communicate and/or interact with various other systems including, for example, braking systems, steering system, engine systems, transmission systems, speed control systems, and/or camera systems to control various functions of the vehicle.

It may be desirable for the navigation system to be configured to communicate with various other vehicle systems. For example, the navigation system may be configured to communicate with the vehicle control system so that the various outputs issued by the turn control device may cause the turn signals of the vehicle to be activated and/or deactivated as described above. Also for example, the navigation system may be configured to communicate with the autonomous vehicle control system to enable the autonomous vehicle control system to perform driving maneuvers as described above.

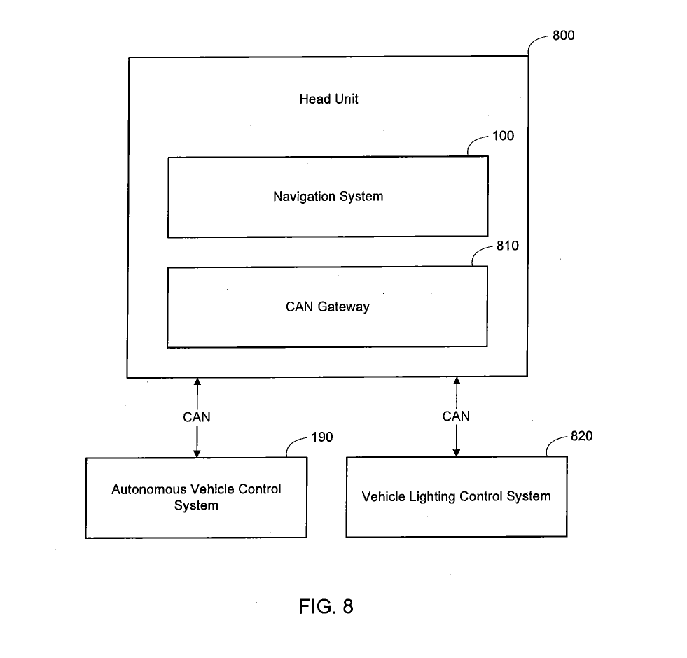

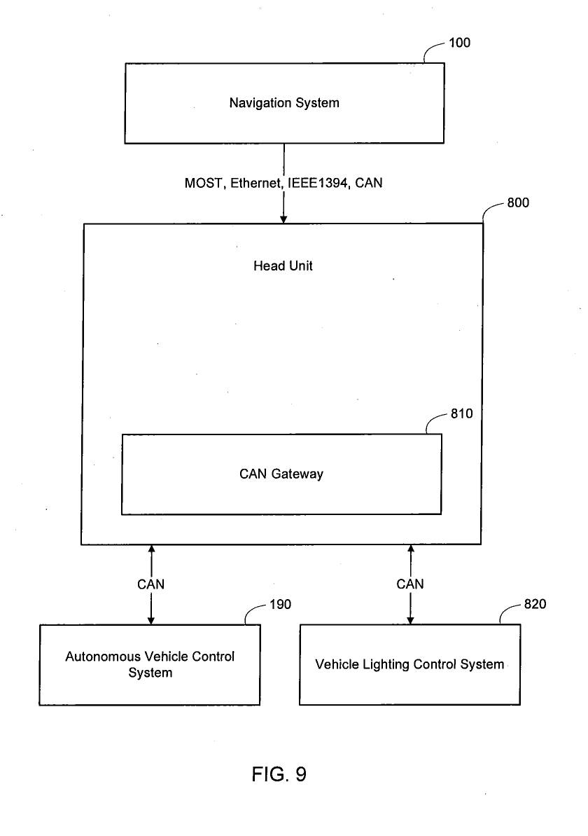

In one example, the navigation system 100 may be integrated into a head unit 800 of the vehicle as shown in FIG. 8. The head unit may include the positioning device 110, the geographical data storage device 120, the processing device 130, the loudspeaker device 142, the optical display device 144, the input device 150, the velocity sensing device 160, the turn control device 170, and/or the locality data storage device 180. Alternatively, the navigation system 100 may be configured as a standalone device as shown in FIG. 9. The standalone navigation system 100 may communicate with the head unit 800 of the vehicle. Communication between the navigation system 100 and the head unit 800 may be accomplished by way of a networking system such as MOST, Ethernet, USB, IEEE 1394, CAN, or any other networking system capable of communication with a protocol. In either of the examples shown in FIGS. 8 and 9, the head unit 800 may include a CAN gateway 810. The head unit 800 may communicate with the vehicle control system, or more particularly, the vehicle lighting system 820 and/or the autonomous vehicle control system 190, via the CAN gateway 810 by way of a CAN. In this manner, the head unit may bridge the infotainment network and the vehicle control network. The head unit may transmit data between the infotainment network and the vehicle control network using any communication means.

While various examples of the invention have been described, it will be apparent to those of ordinary skill in the art that many more examples and implementations are possible within the scope of the invention. Accordingly, the invention is not to be restricted except in light of the attached claims and their equivalents.

We claim:

1. A computer readable medium encoded with computer executable instructions, the computer executable instructions executable with a processor, the computer readable medium comprising:
instructions executable to receive position data;
instructions executable to receive navigation information comprising a preselected navigation route generated by a navigation system;
instructions executable to calculate a state value based on the position data and the navigation information;
instructions executable to determine a state value limit based on at least one of a current velocity of a vehicle, a regulatory limit, and a roadway limit; and
instructions executable to output a control signal when the state value fails to exceed the state value limit.

2. The computer readable medium of claim 1, further comprising instructions executable to receive velocity data comprising the current velocity of the vehicle or instructions executable to calculate the current velocity of the vehicle based on the position data, where the instructions executable to determine the state value limit comprise instructions executable to correlate the current velocity of the vehicle with at least one of velocity-distance data and velocity-time data.

3. The computer readable medium of claim 1, further comprising instructions executable to receive locality data comprising at least one of a regulatory distance limit and a regulatory time limit, where the instructions executable to determine the state value limit comprise instructions executable to correlate a current position of the vehicle with the locality data.

4. The computer readable medium of claim 1, further comprising instructions executable to receive geographical data comprising at least one of a roadway distance limit and a roadway time limit, where the instructions executable to determine the state value limit comprise instructions executable to correlate a current position of the vehicle with the geographical data.

5. The computer readable medium of claim 1, where the state value is a distance to turn value and the state value limit is a distance to turn limit.

6. The computer readable medium of claim 1, where the state value is a time to turn value and the state value limit is a time to turn limit.

7. The computer readable medium of claim 1, where the control signal is a first control signal and the computer executable instructions further comprise instructions executable to analyze at least one of the position data, the current velocity of the vehicle, and the navigation information to detect a complete turn or a bypassed turn and instructions executable to output a second control signal when the complete turn is detected or the bypassed turn is detected.

8. The computer readable medium of claim 7, where the first control signal activates a turn signal of the vehicle and the second control signal deactivates the turn signal of the vehicle.

9. The computer readable medium of claim 7, where the first control signal activates a permissive signal to enable an autonomous vehicle control system to perform a driving maneuver and the second control signal deactivates the permissive signal to prevent the autonomous vehicle control system from performing the driving maneuver.

10. A computer readable medium encoded with computer executable instructions, the computer executable instructions executable with a processor, the computer readable medium comprising:
instructions executable to receive position data;
instructions executable to receive navigation information comprising a preselected navigation route generated by a navigation system;
instructions executable to calculate a state value based on at least two of the position data, a current velocity of a vehicle, and the navigation information;
instructions executable to determine a state value limit based on at least one of the current velocity of the vehicle, a regulatory limit, and a roadway limit; and
instructions executable to output a permissive control signal to an autonomous vehicle control system when the state value fails to exceed the state value limit.

11. The computer readable medium of claim 10, where the permissive control signal enables the autonomous control system to perform a driving maneuver.

12. The computer readable medium of claim 10, further comprising instructions executable to analyze at least one of the position data, the current velocity of the vehicle, and the navigation information to detect a complete turn or a bypassed turn and instructions executable to deactivate the permissive control signal when the complete turn is detected or the bypassed turn is detected to prevent the autonomous vehicle control system from performing a driving maneuver.

13. A computer readable medium encoded with computer executable instructions, the computer executable instructions executable with a processor, the computer readable medium comprising:
instructions executable to initiate a lane change maneuver;
instructions executable to determine a current traffic lane;
instructions executable to determine a target traffic lane;
instructions executable to output a first control signal to enable a vehicle to perform the lane change maneuver and to activate a turn signal of the vehicle;
instructions executable to detect a complete or an abandoned lane change; and
instructions executable to output a second control signal to prevent the vehicle from performing the lane change maneuver and to deactivate the turn signal of the vehicle when the complete or the abandoned lane change is detected.

14. The computer readable medium of claim 13, where initiation of the lane change maneuver is in response to a signal received from an autonomous vehicle control system.

15. The computer readable medium of claim 13, where the first control signal comprises a permissive signal to enable an autonomous vehicle control system to perform the lane change maneuver, and the second control signal deactivates the permissive signal to prevent the autonomous vehicle control system from performing the lane change maneuver.

16. A navigation system for a vehicle, comprising:
a positioning device configured to determine a current position of the vehicle and generate a corresponding position data signal;
a processing device configured to receive the position data signal and generate navigation information; and
a turn control device configured to receive the position data signal and the navigation information; calculate a state value; determine a state value limit based on a regulatory limit and output a control signal when the state value fails to exceed the state value limit.

17. The navigation system of claim 16, where the turn control device is configured to receive a velocity data signal comprising a current velocity of the vehicle or to calculate the current velocity of the vehicle based on the position data signal and to determine the state value limit by correlating the current velocity with at least one of velocity-distance data and velocity-time data.

18. The navigation system of claim 16, where the turn control device is configured to receive locality data comprising at least one of a regulatory distance limit and a regulatory time limit, and to determine the state value limit by correlating the current position with the locality data.

19. The navigation system of claim 16, where the turn control device is configured to receive geographical data comprising at least one of a roadway distance limit and a roadway time limit, and to determine the state value limit by correlating the current position of the vehicle with the geographical data.

20. The navigation system of claim 16, where the control signal enables an autonomous vehicle control system to perform a driving maneuver, and the turn control device is configured to analyze at least one of the position data, a current velocity of the vehicle, and the navigation information to detect a complete turn or a bypassed turn, and to deactivate the control signal to prevent the autonomous vehicle control system from performing the driving maneuver when the complete turn is detected or the bypassed turn is detected.
